(19) United States
(12) Patent Application Publication
(10) Pub. No.: US 2019/0197222 A1
(43) Pub. Date: Jun. 27, 2019

(54) SECURE AUDIO OUTPUT

(71) Applicant: Cirrus Logic International Semiconductor Ltd., Edinburgh (GB)

(72) Inventors: Ralph CLARK, London (GB); Ryan ROBERTS, Hertfordshire (GB)

(73) Assignee: Cirrus Logic International Semiconductor Ltd., Edinburgh (GB)

(21) Appl. No.: 16/220,494

(22) Filed: Dec. 14, 2018

Related U.S. Application Data
(60) Provisional application No. 62/608,924, filed on Dec. 21, 2017.

(30) Foreign Application Priority Data
Jan. 30, 2018 (GB) 1801521.4

(51) Int. Cl. G06F 21/32; G06F 3/16; G06Q 20/40

(52) U.S. Cl. CPC G06F 21/32; G06Q 20/40145; G06F 3/167

(57) ABSTRACT

The disclosure provides apparatus and methods for enabling transactions to be conducted securely using audio output signals. One embodiment provides an electronic device, comprising: an audio output; an audio input; interface circuitry; and processing circuitry, configured to: receive, from a remote server via the interface circuitry, an indication of a transaction requested by a user of the electronic device; output one or more output messages for playback via the audio output, the one or more output messages comprising an audio transaction confirmation message comprising an indication of the transaction; receive, from the audio input, one or more input messages spoken by the user, the one or more input messages comprising a transaction confirmation response message; perform a voice biometric authentication algorithm on at least one of the one or more input messages to determine whether the user is an authorised user of the electronic device; and responsive to a determination that the user is an authorised user of the electronic device, output to the remote server, via the interface circuitry, a response message comprising an indication of the audio transaction confirmation message and an indication of the transaction confirmation response message.

### TECHNICAL FIELD

The present disclosure relates generally to devices, systems and methods for providing audio output. Particular embodiments of the disclosure provide devices, systems and methods providing audio output for use in secure and non-secure transactions.

### BACKGROUND

Users are increasingly using electronic devices such as smart phones, computers and tablets to conduct transactions online. Such transactions may be financial (e.g., a purchase of one or more items, a banking instruction, etc), or relate to some other operation (e.g., logging in to an online service). The transactions will generally require some level of security. For example, the electronic device, or the remote server handling the transaction, may require user authentication if the transaction is to be performed.

The FIDO (Fast IDentity Online) Alliance is developing mechanisms which permit authentication online without relying on passwords. One such mechanism is known as “What you see is what you sign”. FIG. 1 is a signalling diagram illustrating this concept.

An electronic device 114 (i.e. a user device) requests performance of an online transaction by a remote server 112. FIG. 1 assumes that certain signalling between the electronic device and the server has already taken place. For example, it may be assumed that the electronic device 114 has sent a message to the server 112 detailing the requested transaction (e.g. a purchase of an item, log-in to an online service, etc). The server 112 thus has knowledge of the transaction requested by the electronic device 114. It may also be assumed that the server 112 and the electronic device 114 have previously exchanged cryptographic signatures, or otherwise agreed upon a mutual session-specific cryptographic signature.

In step 116, the server 112 generates a transaction confirmation (TC) graphical image. The TC image comprises a summary of the requested transaction. In the case of an online purchase, for example, the TC image may comprise information identifying the product which is to be purchased (e.g. a product name, description, image, etc) and the cost. The TC image may additionally comprise information such as the payment method, delivery address, etc.

In step 118, the TC image is transmitted from the server 112 to the electronic device 114, together with a challenge. The challenge may be a cryptographically secure random number, also known as a “nonce”. Both challenge and TC image are cryptographically signed with the server's signature, or a session-specific signature.

The “what you see is what you sign” method assumes the presence of a secure processing environment in the electronic device 114. For example, the electronic device may comprise a stand-alone secure processor (i.e., in addition to a general-purpose processor or applications processor), or a trusted execution environment (TEE) established within a general-purpose or applications processor.

In step 120, the secure processing environment controls the electronic device 114 to securely display the TC image to the user. For example, the secure processing environment may take over the screen, to avoid malicious overwrites. The display may be contingent upon a verification process verifying that the TC image and challenge are signed with a signature which corresponds to the signature stored in the electronic device for the server 112 or the session.

Thus a summary of the proposed transaction is presented to the user of the electronic device 114. The user may then authorise the transaction and authenticate him- or herself using one or more biometric authentication techniques in step 122. Numerous methods are possible for this. The authorisation and authentication may be simultaneous. One well-known example may require a user to both authorise the transaction and authenticate himself using a fingerprint sensor in the electronic device 114. Alternatively, the authorisation and authentication may be separate processes. For example, a user may authenticate himself using a fingerprint sensor, or voice biometrics, and subsequently authorise the transaction by separate input to the electronic device 114 (e.g., by clicking or tapping on an “authorise” button).

In step 124, the electronic device 114 transmits the biometric result and the challenge back to the server 112. Both may be signed using a signature belonging to the electronic device 112, or the session-specific signature. In step 126, responsive to a determination that the signature corresponds to the signature which is stored on the server 112 for the device 114 or the session, the server 112 may perform the requested transaction.

The method illustrated in FIG. 1 thus provides a secure method for authorising online transactions. However, the method assumes and requires that a secure element in the electronic device 114 will control what is displayed to the user.

Increasingly, users are seeking to interact with electronic devices without utilizing a display, either because the electronic device does not comprise a display, or because it is inconvenient to interact with the display. For example, smart home devices (such as Amazon Echo (RTM) and Google Home (RTM)) are becoming popular and do not comprise a significant display. Instead, users interact with such devices using their voice. Similarly, users of smart phones and the like may wish to control their device using their voice.

Accordingly, users may wish to request and authorise online transactions in a similar manner to that shown in FIG. 1, but using their voice. However, this presents a problem, as current standards allow only for a visual representation of the proposed transaction to be authorised (i.e. the TC image).

Embodiments of the present disclosure seek to overcome this and other problems.

### SUMMARY

In one aspect, the disclosure provides an electronic device, comprising: an audio output; an audio input; interface circuitry; and processing circuitry, configured to: receive, from a remote server via the interface circuitry, an indication of a transaction requested by a user of the electronic device; output one or more output messages for playback via the audio output, the one or more output messages comprising an audio transaction confirmation message comprising an indication of the transaction; receive, from the audio input, one or more input messages spoken by the user, the one or more input messages comprising a transaction confirmation response message; perform a voice biometric authentication algorithm on at least one of the one or more input messages to determine whether the user is an authorised user of the electronic device; and responsive to a determination that the user is an authorised user of the electronic device, output to the remote server, via the interface circuitry, a response message comprising an indication of the audio transaction confirmation message and an indication of the transaction confirmation response message.

In another aspect, the present disclosure provides audio processing circuitry, comprising: a first input for receiving non-secure audio output signals; a second input for receiving secure audio output signals; an audio output; routing circuitry coupled to the first input, the second input and the audio output, for routing audio signals from the first and second inputs to the audio output according to a routing configuration; and a security module operative to: determine whether the routing configuration complies with one or more rules; and, responsive to a determination that the routing configuration does not comply with the one or more rules, set a flag.

In a further aspect, the present disclosure provides audio processing circuitry, comprising: a first input for receiving non-secure audio output signals; a second input for receiving secure audio output signals; an audio output; routing circuitry coupled to the first input, the second input and the audio output, for routing audio signals from the first and second inputs to the audio output according to a routing configuration; and a security module operative to: receive a control signal requesting to change the routing configuration; determine whether the control signal complies with one or more rules; and, responsive to a determination that the control signal does not comply with the one or more rules, refusing the request to change the routing configuration.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a signalling diagram illustrating a “what you see is what you sign” method;

FIG. 2 is a signalling diagram illustrating a method according to embodiments of the disclosure;

FIG. 3 is a schematic diagram showing an electronic device according to embodiments of the present disclosure;

FIG. 4 is a schematic diagram showing audio processing circuitry for audio output according to embodiments of the disclosure;

FIG. 5 is a schematic diagram showing audio processing circuitry for audio output according to further embodiments of the disclosure; and

FIG. 6 is a schematic diagram showing audio processing circuitry for audio input according to embodiments of the disclosure.

### DETAILED DESCRIPTION

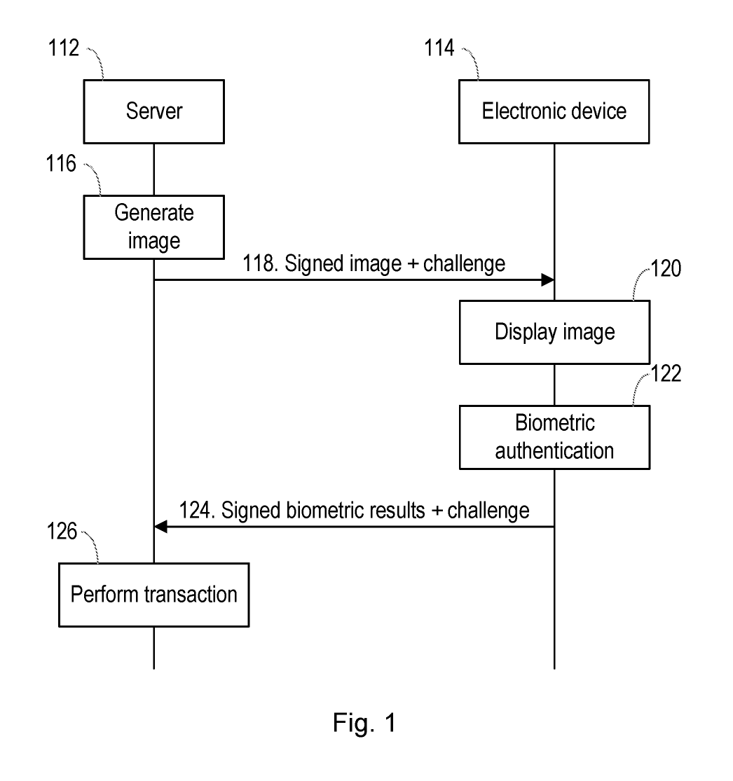

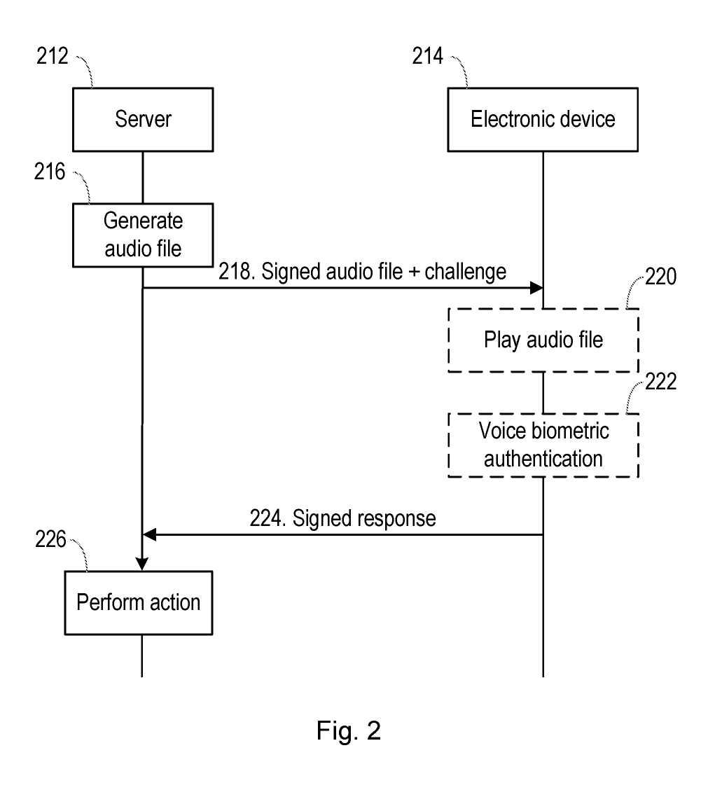

FIG. 2 is a signalling diagram of a method according to embodiments of the disclosure. As with FIG. 1, an electronic device 214 (i.e. a user device) requests performance of an online transaction by a remote server 212. Certain signalling between the electronic device and the server may have already taken place. For example, the electronic device 214 may have sent a message to the server 212 detailing the requested transaction (e.g. a purchase of an item, log-in to an online service, etc). The transaction may be requested via any suitable input to the electronic device from the user. In one embodiment, however, the transaction may be requested via an audio input. For example, the user may utter a command phrase (e.g., “I would like to buy a litre of milk”), which is received by a microphone associated with the electronic device (e.g., a microphone provided within the device, or within a peripheral device connected to the device). The command phrase may be subjected to a speech recognition process, either within the electronic device itself, or via a remote server providing speech recognition functionality.

The server 212 thus has knowledge of the transaction requested by the electronic device 214. The server 212 and the electronic device 214 may also have previously exchanged cryptographic signatures, or otherwise agreed upon a mutual session-specific cryptographic signature.

In step 216, the remote server 212 generates an audio file comprising a summary or indication of the requested transaction. The summary may comprise sufficient information to enable the user of the electronic device to determine the nature of the transaction which is subject to authorisation. For example, in the case of a financial transaction, the summary may comprise an indication of the product(s) which are to be purchased and their cost. The summary may further comprise retailer information (e.g. the identity of the retailer from which the product is to be purchased), payment information (e.g., the method of payment), delivery information (e.g., the delivery address), and so on. The audio file may be phrased as a statement or a question, e.g., “are you sure you wish to purchase a litre of milk?” When the transaction is not financial, the summary may comprise an indication of the action which is to be carried out, e.g., “are you sure you wish to delete your user account?” Those skilled in the art will appreciate that many different formats are possible; the present application is not limited in that respect.

In step 218, the server 212 sends the audio file to the electronic device 214, in addition to a challenge. The challenge may be a cryptographically secure random number, also known as a “nonce”. Both the audio file and the challenge may be signed by a cryptographic signature associated with the server 212, or with the session established between the server 212 and the device 214.

The electronic device 214 thus receives an indication of the proposed transaction from the server 212. The method may proceed in multiple ways in order to authorise the transaction in a secure manner. The common subject matter of these multiple methods is set out in FIG. 2; however, the order of the steps, as well as their precise detail, may vary from method to method.

Thus, in step 220, the electronic device 214 plays the audio file to the user. The electronic device 214 may comprise a built-in loudspeaker and play the audio file through that speaker; alternatively, the electronic device 214 may comprise an audio output interface for connection to a peripheral device (such as headphones, or a headset, etc) or an external loudspeaker, and output the audio file through that audio output interface. In either case, the user of the electronic device 214 thus listens to an audible summary of the proposed transaction.

As with the “what you see is what you sign” method described above with respect to FIG. 1, one or more security measures may be taken to ensure the audio output corresponds to the audio file received from the server 212.

For example, the audio file received in step 218 is signed with a cryptographic signature associated with the server 212 or the session. Playback of the audio file in step 220 may be contingent upon the electronic device 214 verifying that the signature corresponds to a signature stored for the server 212 or the session locally in the electronic device 214. Alternatively, playback of the audio file may occur regardless of any outcome of the signature verification, but authorisation of the transaction may be prevented or otherwise flagged in the event that the signature verification fails (i.e. the signature does not correspond to the server or session signature). In the latter case, the audio file can be output in parallel with performance of the signature verification process, thus reducing latency in the user experience.

The signature therefore secures the process against “man in the middle” attacks, in which a third-party intercepts and replaces an original audio file transmitted by the server 212 with a spoof audio file. The spoof audio file may contain a false representation of the transaction which is actually proposed to be carried out by the server 212. Thus, the user of the electronic device 214 may authorise a transaction unintentionally, without knowledge of the actual transaction. As the audio file is signed, the electronic device 214 can ensure that the received audio file originated with the server 212 and has not been replaced or otherwise tampered with.

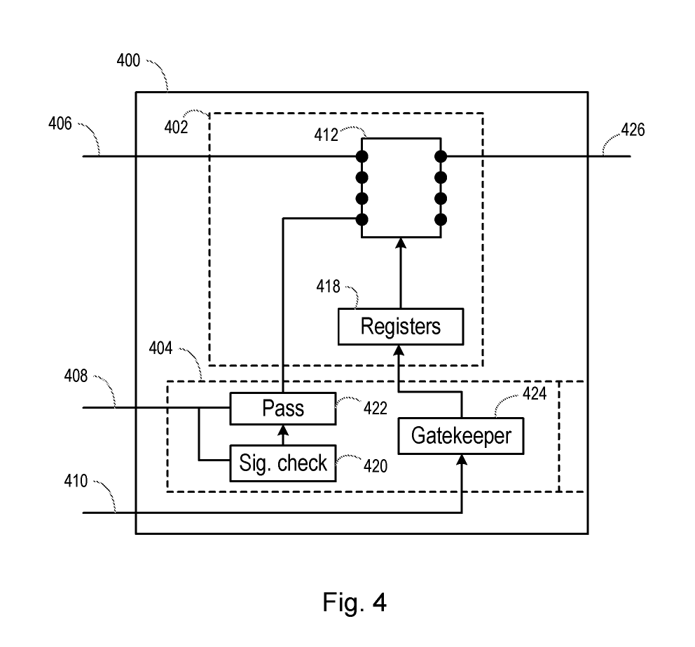

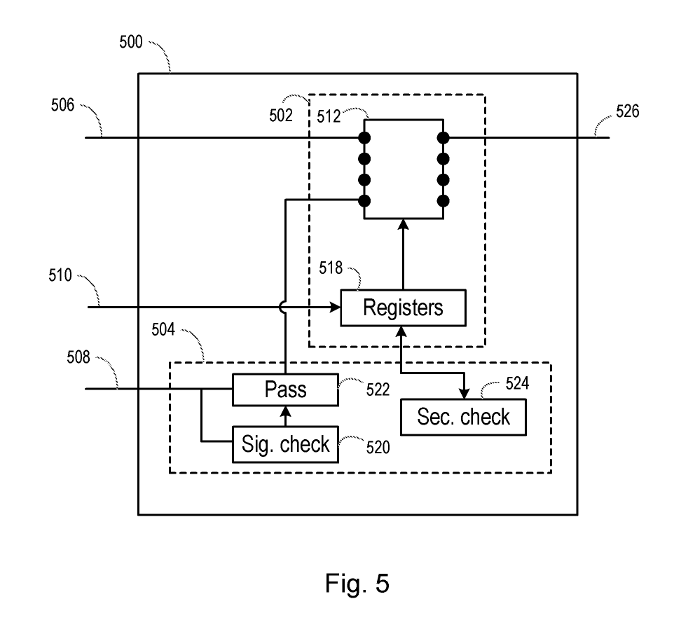

The electronic device 214 may also comprise one or more security measures to ensure the audio file output to the user is the audio file received from the server 212. For example, the electronic device 214 may comprise a secure processing environment (e.g. a secure processor, TEE, etc.) which controls the audio output of the electronic device. Further detail regarding this aspect will be described below with respect to FIGS. 4 and 5.

In step 222, the electronic device 214 performs biometric authentication on the voice of the user to authenticate that the user is an authorised user. This is also known as speaker recognition.

Speaker recognition refers to a technique that provides information about the identity of a person speaking. For example, speaker recognition may determine the identity of a speaker, from amongst a group of previously registered individuals, or may provide information indicating whether a speaker is or is not a particular individual, for the purposes of identification or authentication.

The speaker recognition process may use a particular background model (i.e. a model of the public at large) and a model of the user's speech or “voiceprint” (i.e. as acquired during a previous enrolment process) as its inputs, and compare the relevant voice segment with these models, using a specified verification method to arrive at an output. Features of the user's speech are obtained from the relevant voice segment, and these features are compared with the features of the background model and the relevant user model. Thus, each speaker recognition process can be considered to comprise the background model, the user model, and the verification method or engine that are used. The output (also referred to herein as the biometric authentication result) may comprise a biometric score of the likelihood that a speaker is an authorised user (say, as opposed to a general member of the public). The output may further or alternatively comprise a decision as to whether the speaker is an authorised user. For example, such a decision may be reached by comparing the score to a threshold.

In embodiments of the disclosure, the speaker recognition process is executed in the electronic device 214 itself, such as in the secure processing environment. In this way, biometric information does not leave the electronic device 214 and may not leave the secure processing environment.

Speaker recognition may be performed on different voice inputs, according to different embodiments of the disclosure. For example, in one embodiment, the audio file is output to the user in step 220, and the user responds in step 222. The speaker recognition process may be performed on the user's response to the audio file. Consider the following use case:
Device: “Are you sure you want to you purchase a litre of milk?”
User: “Yes I wish to purchase a litre of milk”.

The electronic device may perform a voice biometric authentication algorithm on the user's reply. This has the advantage that the user is not required to provide multiple inputs in order to authorise the transaction. The user is authenticated and the transaction is authorised using a single voice input.

A disadvantage of this method is that insufficient input may be provided to enable the biometric algorithm to authenticate the user. For example, if the user responds with a simple “yes”, there may be insufficient data to authenticate the user as an authorised user of the electronic device (depending on the efficiency of the biometric authentication algorithm). Thus, the electronic device 214 may conduct an additional voice biometric process in order to authenticate the user. For example, the electronic device 214 may issue an audio challenge to the user: “Please verify yourself”, to which the user can respond with a longer response phrase, e.g. “my voice is my password”. Speaker recognition may then be carried out on the response phrase to authenticate the user as an authorised user.

The separate authentication process may be carried out before the audio file is played back to the user, or after the user has responded to the audio file. In the latter case, the separate authentication process may be carried out responsive to failure of a speaker recognition process performed on the user's response. For example, if the electronic device 214 determines that the user's response contained insufficient data for the speaker recognition process to authenticate the user, the separate authentication process may be instigated.

Of course, the user's response may be positive or negative: the user may authorise the transaction or forbid it. Thus a speech recognition process may be performed on the spoken response in order to determine the nature of the response. Speech recognition is a computationally intensive process, and therefore the majority of today's devices (particularly mobile devices, which may have limited processing capabilities) transmit spoken input to a remote server which performs speech recognition. Thus in one embodiment, the electronic device 214 transmits the spoken response to a remote server, which conducts a speech recognition process on the response and returns a textual representation of the response. Transmission of the spoken response and the returned textual data may be subject to cryptographic signatures in a similar manner to that described above for communications between the device 214 and the server 212, to secure the process against man-in-the-middle attacks.

Alternatively, speech recognition may be performed in the electronic device 214 itself. For example, the electronic device 214 may have sufficient processing capabilities, and/or the response may be sufficiently simple (i.e. “yes” or “no”) that the speech can be recognized without introducing excessive latency.

In step 224, the electronic device 214 transmits a response message to the server 212. The response may be cryptographically signed in a similar manner to the response message described above with respect to step 124.

The response message may comprise an indication of the user's response. This may comprise a decoded indication of the response, e.g. yes/no, positive/negative, 0/1, etc, or the audio response itself. The latter case may be particularly useful when the electronic device 214 is unable to perform speech recognition itself; instead, speech recognition may be instigated by the server 212.

The response message may comprise an indication of the audio output from the device 214, i.e. the audio output to which the user responded. For example, the indication may comprise a hash of the audio output.

The response message may comprise an indication of the biometric authentication outcome, i.e. an indication as to whether or not the user was authenticated as an authorised user of the device in step 222. Alternatively, if the biometric authentication is unsuccessful, the electronic device 214 may simply not transmit a response message in step 224, or transmit an error message.

The response message may comprise the challenge received in step 218, so that the server 212 can check the integrity of the transmission chain between the server 212 and the electronic device 214 and, for example, prevent replay attacks.

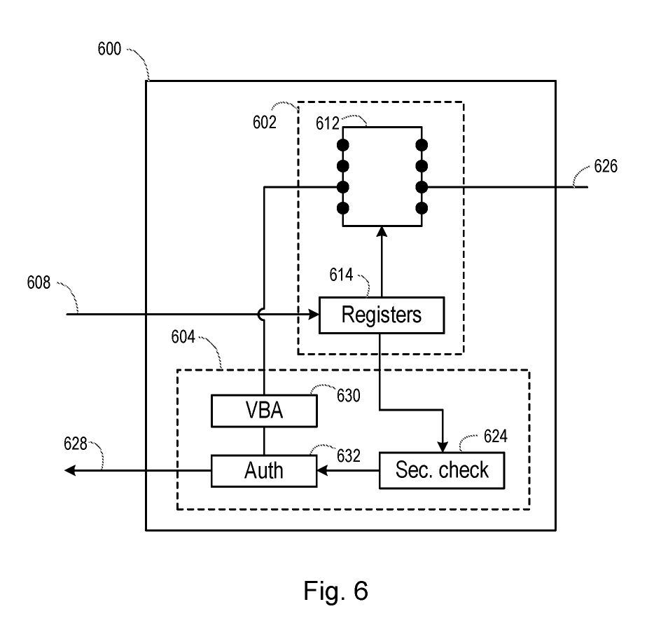

The response message may comprise an indication as to whether routing in the electronic device 214 was secure at the time of audio playback and/or receipt of the user's response. This aspect will be described in further detail with respect to FIGS. 5 and 6 below.

As with other messages transmitted between the device 214 and the server 212, the response message may be cryptographically signed with a signature for the device 214 or the session.

In step 226, the server 212 performs the requested transaction. It will be noted that performance of the transaction may depend on the contents of the response message received in step 224. For example, if the user's response is negative, the transaction may not be performed; if the biometric authentication result is negative; the transaction may not be performed; if the routing in the electronic device was insecure, the transaction may not be performed; if the indication of the audio output does not match the audio file generated in step 216 (or corresponding hashes of the audio data do not match), the transaction may not be performed.

Thus FIG. 2 illustrates a method for the secure processing of a transaction based on audio output (i.e., “what you hear is what you sign”) and audio input from the user.

Those skilled in the art will appreciate that alternative methods to that shown in FIG. 2 may be used without departing from the scope of the claims appended hereto. For example, FIG. 2 illustrates the server 212 generating an audio file comprising a summary of the requested transaction. This audio file is provided to the electronic device 214 and played back to the user. In alternative methods, the remote server 212 may provide to the electronic device 214 an indication of the requested transaction in some other data format. For example, the remote server 212 may provide the text of an audio message, with the electronic device 214 translating that text input into an audio output (e.g. a computer-generated speech output). Alternatively, the remote server 212 may provide an indication of the requested transaction in an arbitrary data format, with the electronic device generating an audio summary of the transaction itself based on the received indication.

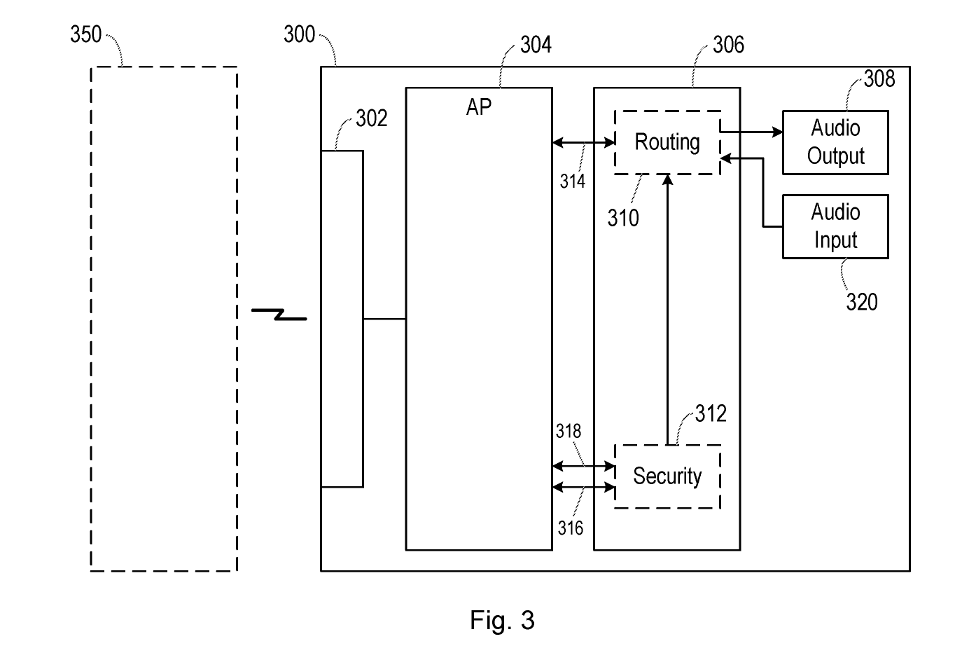

FIG. 3 is a schematic diagram of an electronic device 300 according to embodiments of the disclosure. Also illustrated is a remote server 350, with which the electronic device 300 is able to communicate. The remote server 350 and the electronic device may respectively carry out the actions of the server 212 and device 214 described above with respect to FIG. 2.

The electronic device 300 may be a portable and/or battery powered host device such as a mobile telephone, an audio player, a video player, a PDA, a mobile computing platform such as a laptop computer or tablet and/or a games device for example. The electronic device 300 may also comprise other forms of device such as a remote controller device, a toy, a machine such as a robot, a home automation controller or suchlike.

The electronic device 300 comprises interface circuitry 302, processor circuitry 304, audio processing circuitry 306, an audio output 308 and an audio input 320.

The interface circuitry 302 allows the electronic device 300 to connect to one or more external networks or devices, via wired and/or wireless transmissions. For example, the interface circuitry 302 may comprise hardware suitable for the transmission and reception of wireless signals (such as one or more antennas, transceiver circuitry, etc.)

configured via any suitable wireless protocol (such as WiFi (RTM), cellular, Bluetooth (RTM) etc.). The interface circuitry 302 may additionally or alternatively comprise hardware suitable for the transmission and reception of wired signals (such as connectors and controllers, etc.) configured via any suitable protocol (such as USB). According to embodiments of the disclosure, the interface circuitry 302 is configured to receive an audio file (or otherwise an indication of a requested transaction) from the server 350 (e.g., as described above with respect to step 216), and to transmit a response to the server 350 (e.g., as described above with respect to step 224).

The interface circuitry 302 is coupled to the processing circuitry 304. The processing circuitry 304 may be any suitable processor or combination of processors. For example, the processing circuitry 304 may comprise a general-purpose processor, or an applications processor (AP).

The audio processing circuitry 306 may comprise processing circuitry which is separate from the processing circuitry 304 (as illustrated schematically in FIG. 3), or may form part of the processing circuitry 304. In the former case, the audio processing circuitry may be provided on a separate integrated circuit or chip.

The audio output 308 comprises hardware for the output of audio signals from the device 300. As an example, the output 308 may therefore comprise one or more of: one or more loudspeakers, for the generation of acoustic signals; and a connector (e.g., USB, audio jack, etc.) for the output of digital or analogue audio signals to a peripheral device comprising such a loudspeaker (such as an external loudspeaker, a headset, earphones, etc.). Similarly, the audio input 320 comprises hardware for the input of audio signals to the device 300. The input 320 may therefore comprise one or more of: one or more microphones, for the detection of acoustic signals; and a connector (e.g., USB, audio jack, etc.) for the input of digital or analogue audio signals from a peripheral device comprising such a microphone (such as an external microphone, a headset, etc.).

The audio processing circuitry 306 comprises a routing module 310 and a secure processing environment 312, which will be described in greater detail below and with respect to FIGS. 4, 5 and 6. The secure processing environment 312 may comprise a trusted execution environment (particularly where the audio processing circuitry 306 is provided as part of the processing circuitry 304).

It will be apparent from FIG. 2 above that the electronic device 300 receives an audio file from the server 350, as part of a method for securely handling an online transaction. The interface circuitry 302 thus receives the audio file and passes it to the processing circuitry 304.

Processing circuitry 304 is coupled to audio processing circuitry 306 via one or more interfaces. Three separate signal paths are illustrated between the processing circuitry 304 and the audio processing circuitry 306 in FIG. 3; however, those skilled in the art will appreciate that the signals may be transmitted over the same interface or different interfaces.

Non-secure audio signals 314 (e.g., music, phone calls, system sounds, etc.) are transferred between the processing circuitry 304 and the audio processing circuitry 306, and particularly between the processing circuitry 304 and the routing module 310. Secure audio signals 316 (e.g., the summary of the transaction) are transferred between the processing circuitry 304 and the audio processing circuitry 306, and particularly between the processing circuitry 304 and the secure processing environment 312. Additionally, control signals 318 may be transferred between the processing circuitry 304 and the audio processing circuitry 306, and particularly between the processing circuitry 304 and the secure processing environment 312.

The routing module 310 routes or mixes or applies gains to audio data received at one or more of its inputs, to one or more of its outputs and thence to other components of the device 300 or audio processing circuitry 306 as required.

The secure processing environment 312 is configured to monitor the routing module 310 in one or more ways (described in greater detail below with respect to FIGS. 4 and 5), in order to ensure that authorisation of the transaction is secure.

FIG. 4 is a schematic illustration of audio processing circuitry 400 according to embodiments of the disclosure. The audio processing circuitry 400 may correspond to the audio processing circuitry 306 described above with respect to FIG. 3. As with that circuitry, the audio processing circuitry 400 comprises a routing module 402 and a secure processing environment 404, and receives non-secure audio signals 406, secure audio signals 408 and control signals 410. The audio processing circuitry 400 further outputs audio signals 426 to an audio output (e.g. audio output 308).

The routing module 402 comprises routing circuitry 412 and one or more registers 418. As described above, the routing circuitry 412 is operable to route, mix or apply gains to audio data received at one or more of its inputs to one or more of its outputs. In the illustrated embodiment, such routing, mixing or application of gain is in dependence on values stored in the registers 418. Thus, the registers 418 stores values which may control which input is routed to which output. More than one input may be routed to the same output, such that the inputs become mixed. Gain may be applied to the audio data at its input to the routing circuitry 412, its output from the routing circuitry 412, or both.

It will be apparent from the discussion above that the routing circuitry 412 may be operative to route signals to more than one audio output. For example, the routing circuitry 412 may comprise respective routing outputs for a first audio output (e.g. an internal loudspeaker) and a second audio output (e.g. an audio connector). Routing outputs may be dynamically defined, as components or peripheral devices are connected to the electronic device 300. Peripheral devices may be authenticated by secure exchange of cryptographic certificates with the audio processing circuitry 400.

Values are written to the registers 418 via control signals 410 received by the audio processing circuitry 400 (e.g., transmitted from the processing circuitry 304). Thus the processing circuitry 304 is able to control the routing of audio signals in the audio processing circuitry. In order to ensure that the routing is secure, particularly when the audio processing circuitry 400 is operative to output the audio summary of the transaction, the control signals 410 may be routed to the registers 418 via the secure processing environment 404, and particularly via a gatekeeper module 424 in the secure processing environment 404.

The gatekeeper module 424 may be operable to ensure that the routing or other processing in the routing circuitry 412 complies with one or more rules. If a control signal 410 instructs the routing circuitry 412 to operate in a manner which does not comply with the one or more rules (or a subset of those rules), the control signal 410 may be prevented from changing the values in the registers 418.

The audio processing circuitry 400 may be operable in one or more modes or use cases, with separate sets of one or more rules for each mode or use case. For example, in a normal mode, the gatekeeper module 424 may apply relatively permissive rules, representing a relatively low level of security. In such a mode or use case, the processing circuitry 304 may be permitted to have control of the values of the registers 418, applying routing, mixing and gains as necessary for performance of the tasks while in the normal mode (e.g., playback of non-secure audio 406).

In a secure mode or use case, the gatekeeper module 424 may apply relatively strict rules, representing a relatively high level of security. In such a mode or use case, the processing circuitry 304 may be permitted to control the values of the registers 418 only within certain limits or bounds. For example, the routing circuitry 412 may be prevented from routing non-secure audio signals 406 to the audio output 308. Alternatively, the routing circuitry 412 may be required to apply relatively high attenuating gain to such non-secure audio signals 406, such that the non-secure signals 406 are relatively quiet (also known as “ducking”) or even inaudibly quiet. For example, the routing circuitry 412 may be required to apply no more than a threshold gain to the non-secure signals 406. The routing circuitry 412 may be required to route the secure audio signals 408 to the audio output 308. The routing circuitry 412 may additionally be required to apply relatively high gain (or prevented from applying attenuating gain), such that the secure audio signals 408 are audible to the user. For example, the routing circuitry 412 may be required to apply at least a threshold gain to the secure signals 408. Alternatively, the gatekeeper module 424 may apply a rule based on the ratio of the secure audio signals 408 to the non-secure audio signals 406 (e.g. based on one or more of their amplitude, magnitude, gain, sound level, etc.). For example, the gatekeeper module 424 may require that the ratio is at least a threshold value.

In the illustrated embodiment, the secure processing environment 404 additionally comprises a signature check or verification module 420 and a pass module 422. The secure audio signals 408 are input to both modules. It will be recalled that the secure audio data may be cryptographically signed by the server 212, 350. The signature check module 420 is operative to check that the signature applied to the audio corresponds to a stored signature which is associated with the server 212, 350 or the session established between the server and the electronic device 214, 300. In the illustrated embodiment, the audio is held at the pass module 422 (which may function as a gate) until the signature check module 420 indicates that the signature verification was successful. If the signature verification is unsuccessful, the audio may be prevented from reaching the routing circuitry 412 and an error code may be generated and output to the processing circuitry 304.

FIG. 4 thus illustrates one embodiment by which a secure processing environment may be used to ensure that secure audio is output to the user, and that insecure audio is either not output to the user, or its volume is lowered.

FIG. 5 is a schematic diagram of audio processing circuitry 500 according to alternative embodiments of the disclosure. Again, the audio processing circuitry 500 may correspond to the audio processing circuitry 306 described above with respect to FIG. 3. The audio processing circuitry 500 further possesses many of the same components and configurations as the audio processing circuitry 400 described above with respect to FIG. 4. Thus the description below focusses on the differences between audio processing circuitry 500 and audio processing circuitry 400. Where a component is not substantively described, it may be considered to have the same or similar functionality as the corresponding component in audio processing circuitry 400.

Audio processing circuitry 500 differs in that the control signals 510 are input directly to registers 518, rather than being vetted by a gatekeeper module in the secure processing environment 504. Thus the processing circuitry 304 is able to write values to the registers 518 directly, and control the routing, mixing and application of gain in the routing circuitry 512.

A security check module 524 in the secure processing environment 504 is coupled to the registers 518, and operative to determine the configuration of the routing circuitry 512. Similar to the gatekeeper module 424, the security check module 524 may determine whether the routing or other processing in the routing circuitry 512 complies with one or more rules. If the configuration of the routing circuity 512 does not comply with the one or more rules (or a subset of those rules), the security check module 524 is operative to set a flag or other such information element indicating that fact. The flag may be used to invalidate a user's authorising response, or to halt output of the secure audio signal. Alternatively, the flag may be used to append an indication of the insecure configuration to the authorisation message transmitted to the processing circuitry 304 and/or the server 350.

Thus the embodiment illustrated in FIG. 5 differs from that shown in FIG. 4, in that insecure configurations are not prevented from occurring in the routing circuitry 512. However, the insecure configuration is noted and appropriate action taken to ensure that the transaction is not authorised.

As with FIG. 4, the audio processing circuitry 500 may be operable in one or more modes or use cases, with separate sets of one or more rules for each mode or use case. For example, in a normal mode, the security check module 524 may apply relatively permissive rules, representing a relatively low level of security. In such a mode or use case, the processing circuitry 304 may be permitted to have control of the values of the registers 518, applying routing, mixing and gains as necessary for performance of the tasks while in the normal mode (e.g., playback of non-secure audio 506).

In a secure mode or use case, the security check module 524 may apply relatively strict rules, representing a relatively high level of security. In such a mode or use case, the processing circuitry 304 may be permitted to control the values of the registers 518 only within certain limits or bounds. For example, configurations in which the routing circuitry 512 routes non-secure audio signals 506 to the audio output 308 may be deemed to have broken one or more rules. Alternatively, configurations may be deemed insecure in which the routing circuitry 512 does not apply relatively high attenuating gain to such non-secure audio signals 506, such that the non-secure signals 506 are relatively quiet (also known as “ducking”) or even inaudibly quiet. For example, the routing circuitry 412 may be required to apply no more than a threshold gain to the non-secure signals 406. Configurations in which the routing circuitry 512 does not route the secure audio signals 508 to the audio output 308 may be deemed insecure. Configurations may be deemed insecure in which the routing circuitry 512 does not apply relatively high gain (or prevented from applying attenuating gain), such that the secure audio signals 508 are audible to the user. For example, the routing circuitry 512 may be required to apply at least a threshold gain to the secure signals 508. Alternatively, the security check module 424 may apply a rule based on the ratio of the secure audio signals 508 to the non-secure audio signals 506 (e.g. based on one or more of their amplitude, magnitude, gain, sound level, etc.). For example, the security check module 524 may require that the ratio is at least a threshold value.

Thus the embodiments illustrated in FIGS. 4 and 5 both show circuitry for ensuring audio playback is secure, i.e., secure audio signals are output from the device as intended, or it is at least noted that secure audio signals were not output or may not have been output as intended. It will be appreciated, however, that the user's response may also be subject to the same security issues. That is, the voice biometric algorithm should operate only on the user's input and not, for example, a spoofed input signal created by malware present in the processing circuitry 304. Further, the biometric input signals from the user to the device may need to be securely routed to the voice biometric module (and not recorded elsewhere for spoofing purposes).

FIG. 6 is a schematic diagram of audio processing circuitry 600 according to embodiments of the disclosure. While the embodiments of FIGS. 4 and 5 may be viewed as alternatives for ensuring secure audio output (e.g., playback), audio processing circuitry 600 comprises components for secure audio input from a user. The audio processing circuitry 600 is thus complementary to the embodiments illustrated in FIGS. 4 and 5, and may be combined with either embodiment to provide circuitry which securely handles audio playback and audio input.

The audio processing circuitry 600 comprises a routing module 602 and a secure processing environment 604, which may correspond to the routing modules 402, 502 and the secure processing environments 404, 504 described above. The routing module 602 comprises routing circuitry 612 coupled to receive an audio input signal 626 (e.g. from audio input 320), and registers 614 which store values controlling the routing, mixing and/or application of gain in the routing circuitry 612 as described above. The routing circuitry 612 and registers 614 may correspond to the routing circuitry 412, 512 and registers 418, 518 described above.

The secure processing environment 604 comprises a voice biometric authentication (VBA) module 630 coupled to the routing circuitry 612, and an authorise module 632 coupled to the VBA module 630. During authentication (e.g., when the user responds to the secure audio transaction summary, or carries out a separate authentication process), voice input signals 626 are routed by the routing circuitry 612 to the VBA module 630, which performs a speaker recognition or voice biometric authentication process on the signals to determine whether the speaker is an authorised user or not. It will be understood by those skilled in the art that the audio signals may be subject to one or more processing techniques prior to their input to the VBA module 630, such as noise cancellation, filtering, etc. The VBA module 630 generates a biometric authentication result based on the input signals, and outputs it to the authorise module 632. The authorise module 632 may then generate a response message for onward transmission to the processing circuitry 304 and the server 350 (e.g., as described above in step 224).

In order to ensure secure routing of the input signals, the secure processing environment 604 comprises a security check module 624 coupled to the registers 614, and operative to determine the configuration of the routing circuitry 612. The security check module 624 may be similar to the security check module 524 described above, and in some embodiments may be the same module. Thus, the security check module 624 may determine whether the routing or other processing in the routing circuitry 612 complies with one or more rules.

As with previous Figures, the audio processing circuitry 600 may be operable in one or more modes or use cases, with separate sets of one or more rules for each mode or use case. For example, in a normal mode, the security check module 624 may apply relatively permissive rules, representing a relatively low level of security. In such a mode or use case, the processing circuitry 304 may be permitted to have control of the values of the registers 614, applying routing, mixing and gains as necessary for performance of the tasks while in the normal mode (e.g., input of spoken audio during a phone call).

In a secure mode or use case, the security check module 624 may apply relatively strict rules, representing a relatively high level of security. In such a mode or use case, the processing circuitry 304 may be permitted to control the values of the registers 614 only within certain limits or bounds. For example, configurations in which the routing circuitry 612 routes non-secure audio signals to the VBA module 630 may be deemed to have broken one or more rules. Configurations in which the routing circuitry 612 does not route the audio input signals 626 to the VBA module 330, or routes the audio input signals to the processing circuitry 304 may be deemed insecure (due to the possibility of those input signals being recorded for later spoofing purposes).

If the configuration of the routing circuity 612 does not comply with the one or more rules (or a subset of those rules), the security check module 624 is operative to set a flag or other such information element indicating that fact. The flag may be used to invalidate a user's authorising response, or to halt output of the secure audio signal. Alternatively, the flag may be used to append an indication of the insecure configuration to the authorisation message transmitted to the processing circuitry 304 and/or the server 350.

The flag may be read by the authorising module 632, or a message may be transmitted between the security check module 624 and the authorising module 632, which can then take appropriate action. For example, the authorising module 632 may adapt the response message to indicate that the routing was insecure, or may invalidate the biometric authentication result.

The embodiment of FIG. 6 thus has many similarities with the embodiment of FIG. 5. In FIG. 5, the security check module 524 checks for secure routing during audio playback; in FIG. 6, the security check module 624 checks for secure routing during audio input. Those skilled in the art will appreciate alternative embodiments may be provided having similarities with FIG. 4. That is, a gatekeeper module may be provided to ensure that control signals for the routing circuitry 612 during audio input comply with one or more rules.

The present disclosure thus provides methods, apparatus and computer-readable media which allow transactions to be conducted securely using audio interactions with an electronic device.

The skilled person will thus recognise that some aspects of the above-described apparatus and methods, for example the calculations performed by the processor may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the disclosure will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Embodiments of the disclosure may be arranged as part of an audio processing circuit, for instance an audio circuit which may be provided in a host device. The audio processing circuit may be configured to perform the methods described herein by executing program code (e.g. firmware) stored in memory in the host device. A circuit according to an embodiment of the present disclosure may be implemented as an integrated circuit.

Embodiments may be implemented in an electronic device, especially a portable and/or battery powered host device such as a mobile telephone, an audio player, a video player, a PDA, a mobile computing platform such as a laptop computer or tablet and/or a games device for example. Embodiments of the disclosure may also be implemented wholly or partially in accessories attachable to a host device, for example in active speakers or headsets or the like. Embodiments may be implemented in other forms of device such as a remote controller device, a toy, a machine such as a robot, a home automation controller or suchlike.

It should be noted that the above-mentioned embodiments illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1. An electronic device, comprising:
an audio output;
an audio input;
interface circuitry; and
processing circuitry, configured to:
receive, from a remote server via the interface circuitry, an indication of a transaction requested by a user of the electronic device;
output one or more output messages for playback via the audio output, the one or more output messages comprising an audio transaction confirmation message comprising an indication of the transaction;
receive, from the audio input, one or more input messages spoken by the user, the one or more input messages comprising a transaction confirmation response message;
perform a voice biometric authentication algorithm on at least one of the one or more input messages to determine whether the user is an authorised user of the electronic device; and
responsive to a determination that the user is an authorised user of the electronic device, output to the remote server, via the interface circuitry, a response message comprising an indication of the audio transaction confirmation message and an indication of the transaction confirmation response message.

2. The electronic device according to claim 1, wherein the voice biometric authentication algorithm is performed on the transaction confirmation response message

3. The electronic device according to claim 1, wherein the one or more output messages further comprises a verification request message, wherein the one or more input messages further comprises a verification response message, and wherein the voice biometric authentication algorithm is performed on the verification response message.

4. The electronic device according to claim 1, wherein the indication of the transaction received from the remote server comprises the audio transaction confirmation message.

5. The electronic device according to claim 1, wherein the indication of the transaction received from the remote server is cryptographically signed, and wherein output of the response message is responsive to a determination that the indication of the transaction is cryptographically signed with a signature corresponding to a stored signature for the remote server or a session established between the electronic device and the remote server.

6. The electronic device according to claim 5, wherein output of the audio transaction confirmation message is responsive to a determination that the indication of the transaction is cryptographically signed with a signature corresponding to a stored signature for the remote server or a session established between the electronic device and the remote server.

7. The electronic device according to claim 1, wherein the indication of the audio transaction confirmation message comprises a hash of the audio transaction confirmation message.

8. The electronic device according to claim 1, wherein the indication of the transaction confirmation response message comprises a positive or negative authorisation of the transaction.

9. The electronic device according to claim 1, wherein the indication of the transaction confirmation response message comprises the transaction confirmation response message.

10. The electronic device according to claim 1, wherein the processing circuitry is configured to detect a routing configuration of the one or more output messages, determine whether the routing configuration complies with one or more rules and, responsive to a determination that the routing configuration does not comply with one or more rules, set a flag.

11. The electronic device according to claim 10, wherein the processing circuitry is configured to, responsive to setting of the flag, perform one of the following actions:
prevent output of the one or more output messages;
halt or invalidate the voice biometric algorithm;
prevent output of the response message to the remote server;
invalidate the indication of the transaction confirmation response message; and
add, to the response message, an indication that the routing configuration was insecure.

12. The electronic device according to claim 1, wherein the processing circuitry is configured to detect a routing configuration of the one or more input messages, determine whether the routing configuration complies with one or more rules and, responsive to a determination that the routing configuration does not comply with one or more rules, set a flag.

13. The electronic device according to claim 12, wherein the processing circuitry is configured to, responsive to setting of the flag, perform one of the following actions:
halt or invalidate the voice biometric algorithm;
prevent output of the response message to the remote server;
invalidate the indication of the transaction confirmation response message; and
add, to the response message, an indication that the routing configuration was insecure.

14. Audio processing circuitry, comprising:
a first input for receiving non-secure audio output signals;
a second input for receiving secure audio output signals;
an audio output;
routing circuitry coupled to the first input, the second input and the audio output, for routing audio signals from the first and second inputs to the audio output according to a routing configuration; and
a security module operative to:
determine whether the routing configuration complies with one or more rules; and
responsive to a determination that the routing configuration does not comply with the one or more rules, set a flag.

15. The audio processing circuitry according to claim 14, wherein the one or more rules comprise a rule that non-secure audio output signals must not be routed to the audio output.

16. The audio processing circuitry according to claim 14, wherein the one or more rules comprise a rule that non-secure audio output signals must be attenuated before routing to the audio output.

17. The audio processing circuitry according to claim 14, wherein the one or more rules comprise a rule that secure audio output signals must be routed to the audio output.

18. The audio processing circuitry according to claim 14, wherein the one or more rules comprise a rule that secure audio output signals must not be attenuated by more than a threshold.

19. The audio processing circuitry according to claim 14, wherein the one or more rules comprise a rule that a ratio between secure audio output signals and non-secure audio output signals must not fall below a threshold.

20. Audio processing circuitry, comprising:
a first input for receiving non-secure audio output signals;
a second input for receiving secure audio output signals;
an audio output;
routing circuitry coupled to the first input, the second input and the audio output, for routing audio signals from the first and second inputs to the audio output according to a routing configuration; and
a security module operative to:
receive a control signal requesting to change the routing configuration;
determine whether the control signal complies with one or more rules; and
responsive to a determination that the control signal does not comply with the one or more rules, refusing the request to change the routing configuration.
